(19) United States
(12) Patent Application Publication
(10) Pub. No.: US 2013/0153343 A1
(43) Pub. Date: Jun. 20, 2013

(54) MOTOR VEHICLE BRAKE SYSTEM

(71) Applicant: Dr. Ing. h.c.F. Porsche Aktiengesellschaft, Stuttgart (DE)

(72) Inventor: Donatus Neudeck, Stuttgart (DE)

(73) Assignee: DR. ING. H.C.F. PORSCHE AKTIENGESELLSCHAFT, Stuttgart (DE)

(21) Appl. No.: 13/693,320

(22) Filed: Dec. 4, 2012

(30) Foreign Application Priority Data
Dec. 19, 2011 (DE) 10 2011 056 575.2

(51) Int. Cl. B60T 1/06; B60T 1/02

(52) U.S. Cl. CPC B60T 1/065; B60T 1/02
USPC 188/2 R; 188/71.1

(57) ABSTRACT

A motor vehicle brake system has a first brake device (41) that can provide a function of a parking brake (42) and a function of a service brake (43) at an axle (45) of the motor vehicle, and a second brake device (44) that is a separate assembly with respect to the first brake device (41) to assist the function of the service brake (43) made available by the first brake device (41) at the same axle (45) of the motor vehicle.

### CROSS REFERENCE TO RELATED APPLICATION

This application claims priority under 35 USC 119 to German Patent Appl. No. 10 2011 056 575.2 filed on Dec. 19, 2011, the entire disclosure of which is incorporated herein by reference.

### BACKGROUND OF THE INVENTION

FIGS. 1 to 3 show diagrams of motor vehicle brake systems which are known from the prior art.

FIG. 1 shows a motor vehicle brake system 10 with a brake device 11 through which both a function of a parking brake 12 and a function of a service brake 13 can be made available at an axle 14 of the motor vehicle. A brake device 11 that has both the service brake function and the parking brake function made available at the axle 14 usually is embodied as a combination floating-caliper brake.

FIGS. 2 and 3 show prior art motor vehicle brake systems 20 and 30 in which a first brake device 21 or 31 provides the function of the service brake, and a second brake device 22 or 32 at the same axle 23 or 33 provides the function of a parking brake. In FIG. 2, the service brake 21 is a floating-caliper brake and the parking brake 22 is a drum brake. In FIG. 3, the service brake 31 and the parking brake 32 are separate floating-caliper brakes.

The present invention is based on the object of providing a novel motor vehicle brake system.

### SUMMARY OF THE INVENTION

The motor vehicle brake system of the invention comprises a second brake device that is a separate assembly with respect to the first brake device and with which the function of the service brake, which can be made available by the first brake device, can be assisted at the same axle of the motor vehicle.

The motor vehicle brake system of the invention has two separate brake devices that can act on the same axle of the motor vehicle. The first brake device can perform both the function of the parking brake and the function of the service brake, and the second brake device assists or extends the function of the service brake. The subject motor vehicle brake can be used in motor vehicles in which the service brake function of the first brake device may not be sufficient, such as motor vehicles with high performance engines. The function of the service brake in such motor vehicles simply can be simply extended or upscaled by the second brake device. The function and actuation of the first brake device remain unaffected by the second brake device.

The first brake device is a disk brake that preferably is a combination floating-caliper brake that provides the complete parking brake function and that can provide a first part of the service brake function. The second brake device also is a disk brake that preferably is a fixed-caliper brake or as a floating-caliper brake and can provide a second part of the service brake function.

The distribution of the brake components of the combination floating-caliper brake and additional fixed-caliper (or floating-caliper without a parking brake function) is freely configurable, for example through the size of the piston diameters and the effective frictional radius of the two brakes.

### BRIEF DESCRIPTION OF THE DRAWINGS

FIG. 1 is a diagram of a first prior art motor vehicle brake system.

FIG. 2 is a diagram of a second prior art motor vehicle brake system.

FIG. 3 is a diagram of a third prior art motor vehicle brake system.

FIG. 4 is a diagram of a motor vehicle brake system according to the invention.

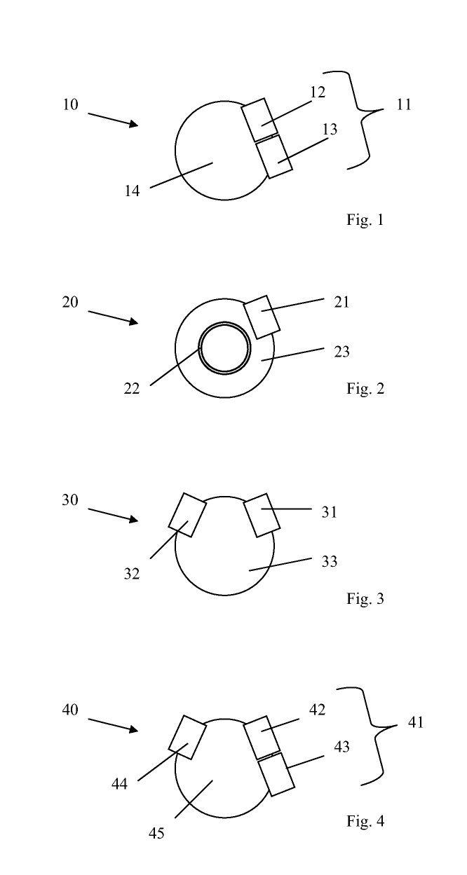

### DETAILED DESCRIPTION OF THE PREFERRED EMBODIMENTS

FIG. 4 is a diagram of a motor vehicle brake system 40 according to the invention. The motor vehicle brake system 40 has a first brake device 41 that can provide a function of a parking brake 42 and a function of a service brake 43 at an axle 45 of the motor vehicle.

The motor vehicle brake system of the invention also has a separate second brake device 44 that acts on the same axle 45 as the first brake device 41. The function of the service brake 43, which is made available by the first brake device 41, is assisted, extended or upscaled with the second brake device 44.

The first brake device 41 makes available a first part of the service brake function, and the second brake device 44 makes available a second part of the service brake function. The distribution of the brake components for the combination floating-caliper brake and the additional fixed-caliper brake (or floating-caliper without a parking brake function) is freely configurable through the size of the piston diameter and the effective friction radius of the two brakes.

The motor vehicle brake system 40 of the invention is particularly effective for motor vehicles with a high performance engine and easily and advantageously extends or assists the function of the service brake 43 that is made available by the first brake device 41 to permit reliable braking of the motor vehicle by means of the service brake in the case of motor vehicles with a high performance engine.

The first brake device 41, which makes available the parking brake 42 and the first part of the service brake 43, preferably is a disk brake, in particular a combination floating-caliper brake.

The second brake device 44, which makes available the second part of the service brake function, also preferably is a disk brake, such as as a fixed-caliper brake or as a floating-caliper brake.

The two brake devices 41 and 44 act on the same axle 45 of the motor vehicle and preferably a rear axle of the motor vehicle. However, both brake devices 41 and 44 of the motor vehicle brake system 40 can act on the front axle of a motor vehicle.

The two brake devices 41 and 44 preferably are hydraulic brake devices.

What is claimed is:

1. A motor vehicle brake system, comprising a first brake device configured to provide a function of a parking brake and a function of a service brake at an axle of the motor vehicle and a second brake device that is separate from the first brake device and that can assist the first brake device to provide the function of the service brake at the same axle of the motor vehicle.

2. The motor vehicle brake system of claim 1, wherein the first brake device is a disk brake that makes available all of the parking brake function and makes available a first part of the service brake function.

3. The motor vehicle brake system of claim 2, wherein the first brake device is a combination floating-caliper brake.

4. The motor vehicle brake system of claim 2, wherein the second brake device is a disk brake that makes available a second part of the service brake function.

5. The motor vehicle brake system of claim 4, wherein the second brake device is a fixed-caliper brake or a floating-caliper brake.

6. The motor vehicle brake system of claim 1, wherein the first brake device and the second brake device are hydraulic brake devices.

7. The motor vehicle brake system of claim 1, wherein the motor vehicle brake system acts on a rear axle of the motor vehicle.
